(19) United States
(12) Patent Application Publication
(10) Pub. No.: US 2004/0133459 A1
(43) Pub. Date: Jul. 8, 2004

(54) Messaging system

(76) Inventors: Adam J Oliver, London (GB); Philip J Dance, Felixstowe (GB)

Correspondence Address: Nixon & Vanderhye, 8th Floor, 1100 North Glebe Road, Arlington, VA, 22201-4714, US

(21) Appl. No.: 10/477,462

(22) PCT Filed: May 17, 2002
(86) PCT No.: PCT/GB02/02338

(30) Foreign Application Priority Data
Jun. 7, 2001 (EP) 01304982.0

(51) Int. Cl. G06F 17/60

(52) U.S. Cl. 705/9

(57) ABSTRACT

A work despatch system in which instructions are transmitted to mobile staff 7, such as the emergency services or operatives of utility providers, has the additional facility to embed recordings 6 of initial customer interactions in the instructions to allow the mobile staff 7 to gain a fuller understanding of the requirements of the customer 4 prior to attending an activity. The recording may be transmitted in the form of an audio file, containing a recording 6 of a telephone conversation, attached to a text instruction (email). To assist the mobile staff, any textual matter, whether in the instructions or the attached recording, may be converted to audio form.

This invention relates to a messaging system for use in the user interface of a work scheduling system. Work scheduling systems are used for allocating work to members of a distributed workforce such as operatives for utility providers (gas, electricity, telecommunications and the like), call-out services (taxis, doctors, plumbers, vehicle repair organisations and the like) or to the emergency services. In general work is allocated to members of the distributed workforce using a form or device based application, in which a dispatcher receives requests for work to be done and allocates the required tasks to the technical staff and other resources at his disposal. This process may be partly or completely automated, as discussed for example in the applicant company's International Patent Specifications WO95/26535 (Granted European Patent 752136, U.S. Pat. No. 5,963,911). and WO98/22897 (Granted European Patent 938714, U.S. patent application Ser. No. 09/043,423), and European Patent application 00311169.7 filed on 20^{th} Dec. 2000.

A problem encountered by members of a workforce working to an allocation scheme of this kind is that the initial contact with the informant reporting the fault or other work requiring attention is not made with the operative who will perform the task, but with a telephonist or dispatcher who is typically in a call centre which may be located a very great distance from the informant. Thus the information passed to the operative is unwittingly filtered by the dispatcher, resulting in the potential loss of relevant information which may be of use to the operative, but not recognised as such by the dispatcher. Furthermore, in entering details on the scheduling system the dispatcher may also misinterpret what is said by the informant. The corrupted or missing information may relate to the nature of the problem to be resolved, details of access to premises, or other information. The significance of this information may not be appreciated by the dispatcher because of lack of technical or local geographical knowledge, or may be misunderstood because of differences in dialect or accent.

In contrast, any operative likely to be allocated the task will necessarily have the relevant technical and local knowledge. If the informant were able to speak directly to the operative, the operative could use his own knowledge to interpret what the informant is saying, and resolve any ambiguities for himself. However, at the time of the initial call by the informant, the work allocation system has yet to determine which of several operatives that will be, as this will depend on how quickly each operative completes the task he is currently working on, (and any others already allocated to him), and whether any more urgent tasks are notified to the allocation system.

Call centre dispatchers' conversations with informants are routinely monitored and recorded for training, quality control, staff monitoring and other purposes.

According to the invention, there is provided an information distribution system comprising recording means for making an audio recording of an initial informant interaction requesting a task to be performed, means for selecting a member of a distributed workforce to perform the said task, means for transmitting an instruction over a telecommunications system to the selected member, and playback means for transmitting, with the instruction, the audio recording of the initial informant interaction.

In another aspect there is provided a method of transmitting information to a distributed workforce, comprising the steps of making an audio recording of an initial informant interaction requesting performance of a task, selecting a member of the distributed workforce to perform the requested task, transmitting instructions to the selected member over a telecommunications system, and transmitting the audio recording with the instructions. Preferably the instructions are created as a text message, to which is attached a sound file carrying an audio recording of a telephone conversation with the informant. The text instructions may be subjected to a speech synthesis process for generation as an audio message.

The ability for the operative to play back the original call interaction between the dispatcher and the informant allows the technician to obtain crucial interaction information, to enable him to understand the issues before he arrives at the worksite. This would be invaluable in removing the “degrees of separation” between the original informant and the operative prior to attending the work.

In the preferred embodiment the initial informant interaction is a telephone conversation between the informant and a party other than the selected operative. Using a voice access service an operative can have his work schedule read to him, and can listen to the initial conversation between the informant and the call centre dispatcher.

An embodiment of the invention will now be described, by way of example, with reference to the Figures, in which

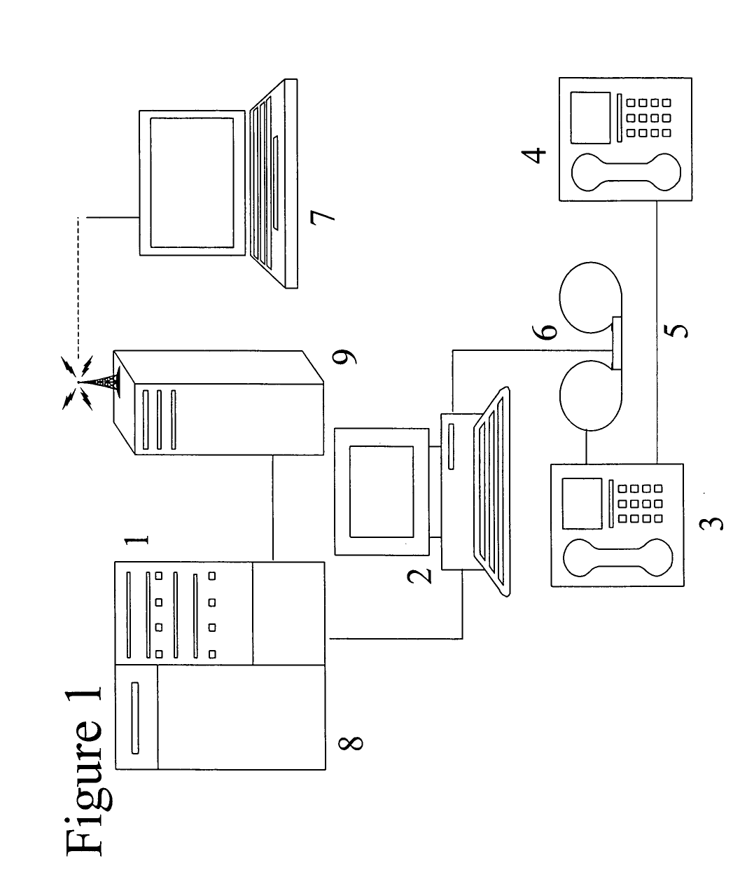

FIG. 1 illustrates schematically the various elements which interact to perform this embodiment of the invention

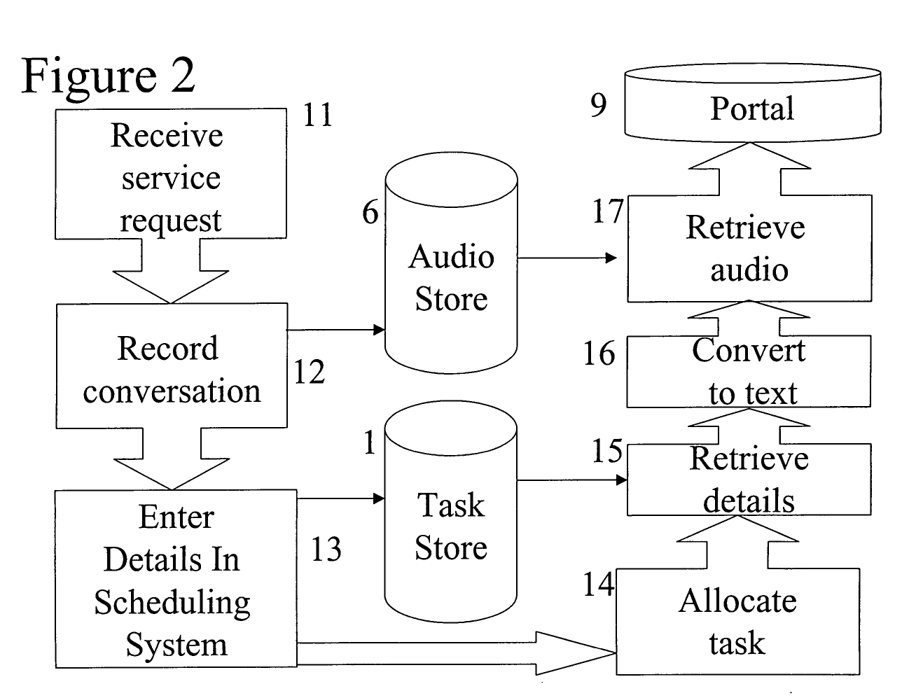

FIG. 2 is a flow chart illustrating the generation of a message according to the invention.

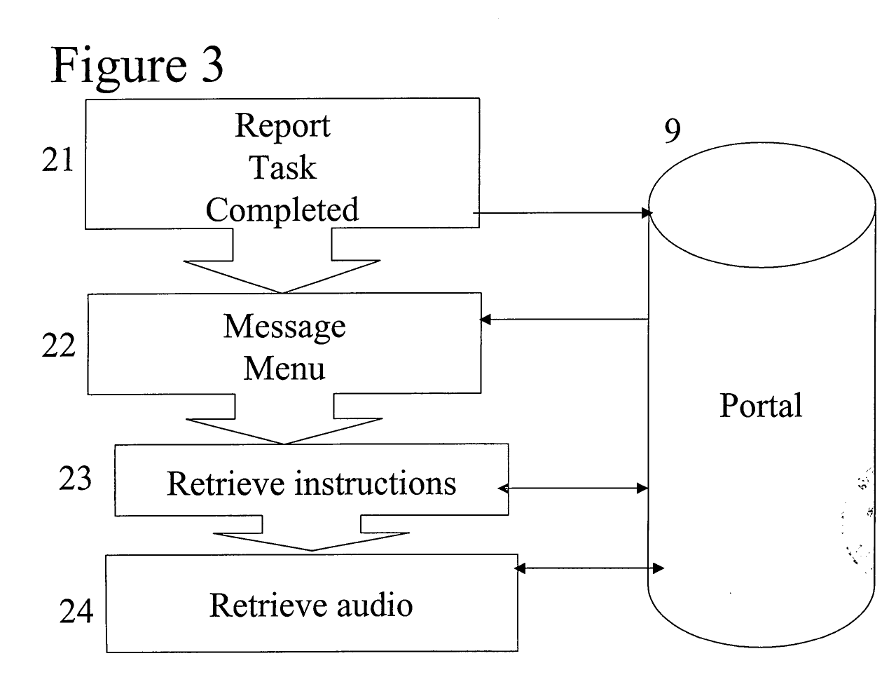

FIG. 3 is a flow chart illustrating the retrieval of a message according to the invention.

In this embodiment the informant is a customer of a telephone company, and the operative is a technician working for that company.

In FIG. 1 there is shown a scheduling system 1 which receives inputs from a user terminal 2. The user operating the terminal has a telephone headset 3 and is in telephone contact with a customer's telephone 4 over a conventional telephone connection 5. A recording device 6 is arranged to record the telephone call. The recordings made by the recording device 6 can be supplied as another input to the scheduling system 1, and are associated with other data relevant to the respective tasks to which they relate.

The scheduling system 1 also receives inputs from technicians' terminals 7 reporting tasks that the technicians have completed. The scheduling system 1 interacts with an allocation processor 8 which processes information received from the user terminals 2 and technician terminals 7 to generate schedules for further work for the technicians, as described in the applicant company's earlier patent applications cited above. These schedules are returned to the scheduling system 1 and the details, including the associated sound recording, may be retrieved by a technician terminal 7 as required. The technician terminal 7 may be a personal digital assistant (PDA) or laptop computer with access to a mobile telecommunications data network, with means for displaying text instructions and playback means for playing sound recordings. The retrieval can take the form of an electronic text message (“email”) with a sound file attachment for the recorded conversation. In another arrangement the terminal 7 may access text (email) through a portal 9 that converts text to synthesised voice messages. In this case the sound file can be arranged to play automatically after the synthesised text message. This arrangement is particularly useful in applications where the user might find reading a text message difficult, such as in poor light conditions or when driving.

The embodiment is operated as follows, as shown in FIG. 2:

The dispatcher operating the call centre terminal 2 receives a call on the headset 3 over the telephone line 5 from a customer (telephone 4) who wishes to be provided a service/report a fault (Step 11). An audio file of the conversation is recorded by the recording apparatus 6 (step 12).

The call centre dispatcher enters the details into the scheduling system 1 (step 13). The text entered by the dispatcher in the terminal 2, to be read out to the terminal 7 by the portal 9could include items such as: the required date and time of the activity, the name and address of the customer, the type of activity required (such as provision/repair), any safety issues, directional instructions to get to the premises, and contact details of the dispatcher originating the task. An example text entered in the scheduling system 1, using the terminal 2, would be as follows:

Subject

Install for N Hammerton, 1 p m Monday 4th June

Message Text

Please install an exchange line for

Mr N, Hamerton

37 Groves Hill Road

Haywards Heath

post code

r h 1, 6 p j

There is a line in the property and customer was a cable subscriber. We have said that we will install between 1 to 3:30 p m. There are no special safety issues. There is parking on site.

An automated mapping system, such as that disclosed in the applicant's earlier European patent application 00311169.7 or European patent 777863 may be used to generate or supplement the text giving directions to the customer location.

Direction Instructions.

From your previous appointment in Crawley, take the A23, then turn left onto the A272. Drive to the town centre and first left past the hospital. Turn left into Heather Bank and then first left into Grove Hill.

The relevant voice file, and a message indicating that there is a voice file attached, may then be retreived from the store 6 automatically or by the action of the dispatcher, and added to the message stored in the portal 9.

Please hold to hear agent contact details and informant interaction.

Regards,

Julia Baker

Call Centre Agent

020 2345 6789

Voice interaction follows for C S S job Q W E, 1 4 3

This message is then stored in the scheduling system 1

When the scheduling system 1 allocates a new task to a technician using the work allocation system 8, (step 14) it retrieves the text message (step 15) and converts the information into a readable format (step 16). The relevant audio file of the original conversation wityh the customer is retrieved from the recording apparatus 6 and attached to the text message (step 18), and they are then despatched to an email account portal 9 or the like (step 17) for retrieval by the technician's terminal 7.

When the technician completes a task and requires instructions relating to his next task he dials into the voice service portal 9 (step 21), reports task completion (for example by a voice activated interface with the scheduling system) and is told how many new messages (activities) are stored for him at the portal 9 (step 22). He can then retrieve a message, which is displayed on a screen of the technician's handset or read out to him by a voice synthesiser in the portal 9 (step 23). Once the message has been transmitted to the technician by the portal 9, a playback of the original customer interaction is performed (step 24), as either an attached sound file (such as a .Wav file) or by access into the recording system 6.

The technician is therefore able to hear what the customer said to the dispatcher, which may be useful in diagnosing any problems reported by the customer, and adding to, or correcting, the details recorded by the dispatcher by text entry. For example, in the above example the dispatcher recorded the address of the informant as “Groves Hill Road”, but the directions refer to “Grove Hill”. The technician may be able to resolve this potential ambiguity by listening to the original conversation. Similarly, the dispatcher may have recorded the appointment time incorrectly, either through mishearing or miskeying: the technician may be able to tell from listening to the conversation what time was actually agreed. The technician may have greater technical knowledge than the dispatcher, so details of the existing installation, such as the suitability of the existing line for the installation proposed, may also be apparent to the technician from details of the conversation, although not included in the text message generated by the dispatcher.

1. An information distribution system comprising recording means for making an audio recording of an initial informant interaction requesting a task to be performed, means for selecting a member of a distributed workforce to perform the said task, means for transmitting an instruction over a telecommunications system to the selected member, and playback means for transmitting, with the instruction, the audio recording of the initial informant interaction.

2. An information distribution means according to any preceding claim wherein the instruction means comprises means for compiling a text message, and the playback means comprises means for attaching an audio file to the text message.

3. A scheduling system according to claim 2, further comprising speech synthesis means for converting the text elements of the message to audio messages.

4. A method of transmitting information to a distributed workforce, comprising the steps of making an audio recording of an initial informant interaction requesting performance of a task, selecting a member of the distributed workforce to perform the requested task, transmitting instructions to the selected member over a telecommunications system, and transmitting the audio recording with the instructions.

5. A method accoring to claim 4, wherein the instructions are created as a text message, to which a sound file carrying an audio recording is attached.

6. A method according to claim 5, wherein the text elements of the message are subjected to a speech synthesis process for generation as an audio message.
